(19) United States
(12) Patent Application Publication
(10) Pub. No.: US 2007/0168726 A1
(43) Pub. Date: Jul. 19, 2007

(54) Processes for assisting in troubleshooting

(75) Inventor: Richard Matthew Amos, Acworth, GA (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation

(21) Appl. No.: 11/239,524

(22) Filed: Sep. 29, 2005

(51) Int. Cl. G06F 11/00

(52) U.S. Cl. 714/25

(57) ABSTRACT

A systematic process is disclosed for isolating customer issues with computer systems and implementing solutions to those issues. A basic troubleshooting methodology provides a systematic approach by which a technician can efficiently define and resolve a customer's problem. The methodology seeks to identify the symptoms and scope of a customer's problem and provides a series of interrelated and layered steps for arriving at a solution to the problem.

### FIELD OF THE INVENTION

This invention relates in general to systematic approaches to troubleshooting or solving problems, and relates in particular to systematic processes for isolating customer issues with computer systems and implementing solutions to those issues.

### BACKGROUND

Users of technical apparatus in general, and of computers and computer-related systems in particular, often require assistance with technical or operating issues relating to those systems. Because most computer-related problems do not require replacement of a failed hardware component, many such issues can be solved by a technical-support person working with the customer or computer user. The customer in such situations may call a source of technical support, sometimes known as a “helpdesk”, staffed with people having technical knowledge or training to assist the callers with most issues likely to occur with particular computer systems or applications. (As used herein, the term “customer” may refer to an individual computer user with whom a technical-support person must work to solve a problem, as well as an entity that acquired the product or application causing the problem.)

Because helpdesk support persons are usually not physically present at the customer's computer, they must talk with the customer by telephone to understand and resolve an event presenting an issue to the customer. Troubleshooting a technical issue with a computer system is not always an easy task for a technician located apart from that computer. Customers, particularly those working with consumer-oriented programs or computers, often are not technically knowledgeable and thus may not understand their problem in terms meaningful to a helpdesk technician. For example, customers calling with issues about their internet service most often present problems to the technicians in a generic sense, for example, “I can't surf the Web”, or “I can't send or receive e-mail”. Those customer statements, although broadly accurate, can be misleading and cause incorrect troubleshooting of the applications and operating system in the customer's computer, when the problem may reside with the customer's hardware or elsewhere. If the technician can avoid troubleshooting solutions based only on a customer's understanding of the problem, both the technician and the customer may avoid wasteful and time-consuming efforts in solving that problem.

### BRIEF SUMMARY OF INVENTION

In accordance with the present invention, the above problems and others are addressed by a basic computer-implemented troubleshooting methodology in which the technician can efficiently close in on a customer's issue with a computer or computer-related application using a systematic approach. In general, the present methodology comprises a series of steps based on a logical approach that can more efficiently target and resolve a customer's problem while avoiding wasteful and time-consuming efforts.

The present methodology seeks to identify the symptoms of a customer's problem and identify the scope of that problem. The methodology then establishes whether anything had changed on the customer's system just before the problem first arose. For example, recent hardware or software changes may be causing the symptoms. Using the troubleshooting methodology, a technician determines the most probable cause of the problem and then implements and tests a solution to the problem. If the solution appears to solve the problem, the methodology guides the technician to recognize any potential side effects of the solution, so that the technician can discuss those with the customer. Lastly, the methodology documents the solution for the particular customer, providing a template for a future technician who may encounter the same problem with the particular customer.

The invention may be implemented as a computer process, a computing system, or as an article or manufacture such as a computer program product or computer readable media readable by a computer system and encoding instructions for executing a computer process.

These and various other features and advantages which characterize the present invention will be apparent from the following detailed description.

### BRIEF DESCRIPTION OF THE DRAWINGS

FIG. 1 illustrates the basic methodology of steps to diagnose and resolve a customer's problem according to a disclosed exemplary embodiment of the present invention.

FIG. 2 illustrates layers involved with implementing several steps in the exemplary embodiment shown in FIG. 1 and applied to troubleshooting a problem with a customer's DSL service.

FIG. 3 illustrates the relationship, according to the disclosed embodiment, between the layers shown in FIG. 2 and exemplary structural and functional elements of a typical DSL connection in which the customer's problem may reside.

FIG. 4 is a flowchart illustrating an application of the present methodology according to the disclosed embodiment.

FIG. 5 illustrates apparatus for computer-assisted implementation of the disclosed embodiment.

### DETAILED DESCRIPTION

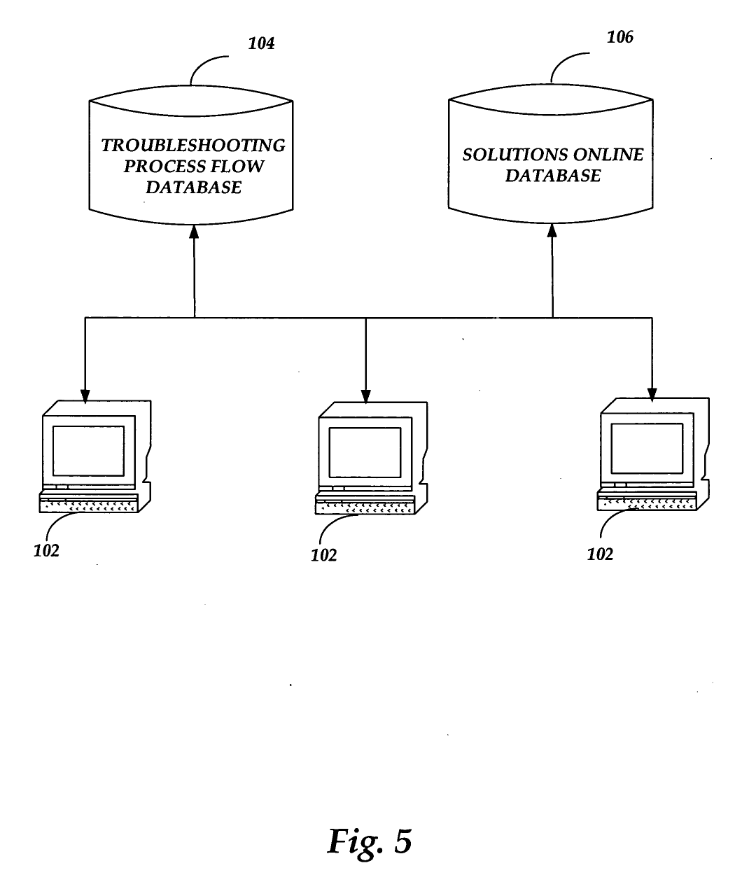

The following describes in detail the troubleshooting methodology of an embodiment of the present invention for troubleshooting problems encountered by customers for digital subscriber line (DSL) internet access service. The description assumes that a DSL customer has called a technician at a helpdesk or elsewhere to assist in solving a problem with the customer's internet access. Referring first to FIG. 5, a typical helpdesk for customer support would include at least one, and preferably several, workstations 102 staffed by technicians equipped for telephone communication with customers contacting the helpdesk seeking assistance with an issue relating to a computer system of the customer. Each workstation 102 is functionally connected with a database 104 for accessing a troubleshooting process flow schema providing a systematic methodology, according to the present invention, for identifying the causes of customer issues relating to the computer system. That particular computer system, as mentioned above, is a source of DSL service for the customer. The workstations 102 also have functional access to a database 106 containing probable solutions for the causes of customer problems identified by the technician in conjunction with the troubleshooting process flow database 104. It should be understood, however, that the methodology of the present invention is not limited to troubleshooting any particular computer application, and that the methodology described herein can be applied to other applications and systems.

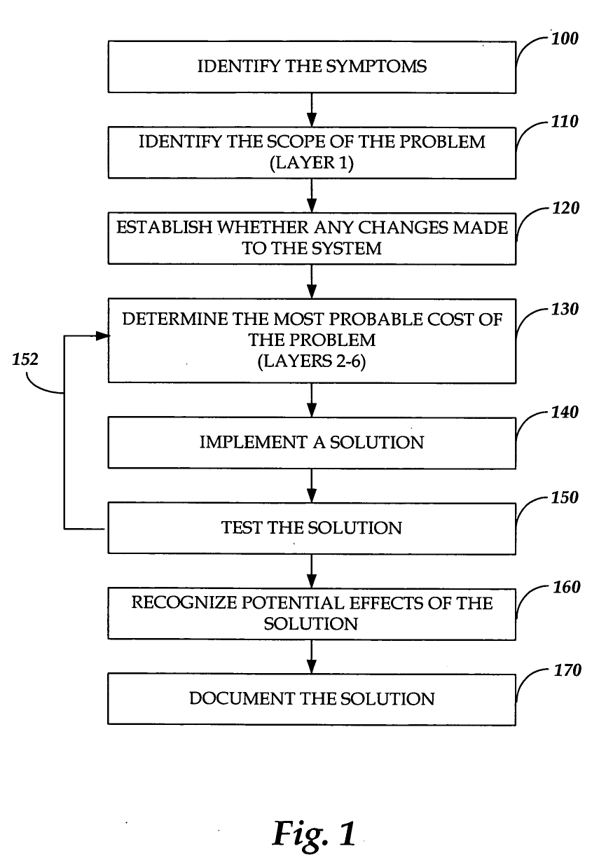

Referring next to FIG. 1, the present methodology requires the technician to identify the symptoms of a customer's problem as at 100. This may consist primarily of listening to what the customer says is happening, for example, “I cannot send or receive e-mail”, or “I get ‘Page can't be displayed’ messages.” The technician should then identify the scope of a customer's problem as shown at 110. The scope of the problem is best identified by determining the outer borders of that problem. For example, if a customer says she can't surf the web, the technician should then find out if she has connectivity through her DSL service with any program. If she does not, then the scope of the problem is a connectivity issue, not a problem with the email program.

The technician then establishes at 120 whether any changes have been made to the computer system. Recent hardware or software changes may be causing the symptoms experienced by the customer. For example, if a customer has recently added a firewall or incorrectly installed a network interface card (NIC), a customer may experience problems that can lead to no-surf issues.

The technician next attempts to determine the most probable cause of the customer's problem, as shown at 130. Determining the most probable cause of a problem is one of the more difficult tasks to accomplish while troubleshooting. There will be times that a probable cause is not always clear to the technician, and for that reason it is important to have an understanding about the problem and at least a general idea of the exact cause of that problem. For example, if the technician determines that a customer has a Winsock error, the technician may not always know what caused the error but he does know it was a corrupt Winsock interface that caused the customer to be unable to surf. With that knowledge, the technician is better able to determine and then implement a solution, the step indicated at 140 in FIG. 1. After locating the appropriate solution, e.g. through the database 106 of solutions maintained on a computer system by the provider of DSL service as in the present embodiment, the technician can verbally walk the customer through the steps to implement that solution.

Having enabled the customer to implement a probable solution, the technician next must help the customer test the solution as at 150 to see whether or not the solution as implemented actually resolves the problem, as perceived by the customer, with the DSL service. If that solution appears to solve the problem, that is, if the customer now can surf the web or connect with e-mail service, the technician should next recognize potential side effects of that solution as at 160 and discuss those effects with the customer. This can be very important, because the solution may impact the customer's computer in ways not foreseen by the customer. For example, if the implemented solution includes disabling a firewall on a customer's computer so that the customer is now able to surf, the helpdesk technician needs to recognize and explain the effects of that action to the customer.

On the other hand, if testing the solution at 150 is determined not to solve the problem, the technician must then return as shown at 152 to determine an alternative probable cause of the problem, and implement and test an alternative solution as before.

Once an effective solution is implemented and successfully tested, the final act of the present methodology is documenting that solution as at 170. Documentation preferably requires placing particulars of the call and appropriate notes into a database maintained or a computer system by the supplier of DSL services or by the supplier of technical support services. Documentation provides an historical record of the steps the technician took to solve a particular customer's problem, which may provide a template for a future customer-support technician who may later encounter the same problem presented by that customer.

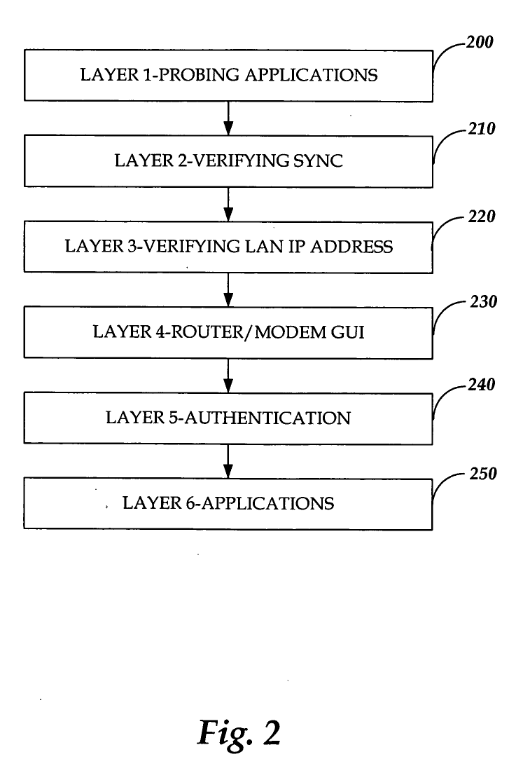

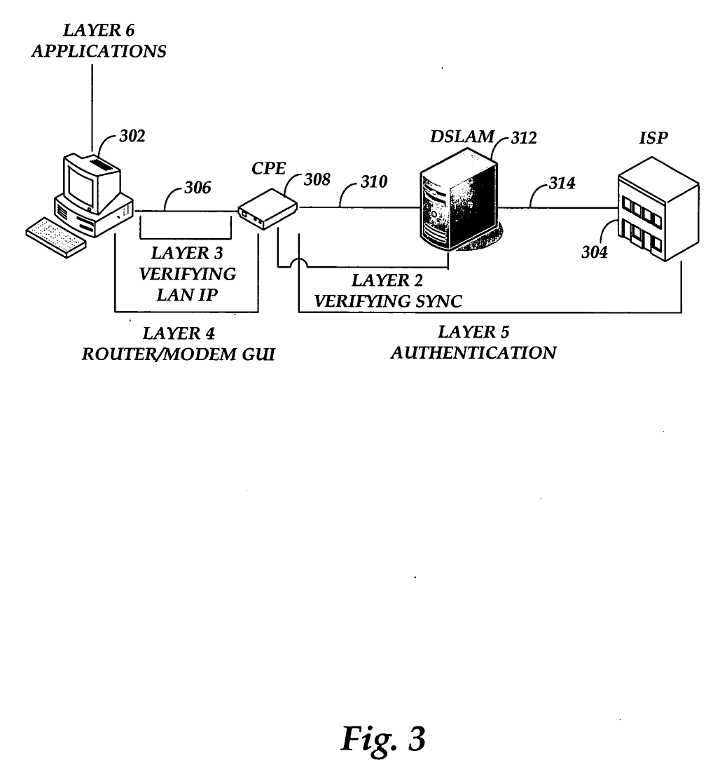

After establishing a step-by-step approach to troubleshooting an issue relating to DSL service, according to the present methodology as in the disclosed embodiment, the methodology focuses on procedures allowing the technician to identify the various places where a failure can happen. The first four steps described with respect to FIG. 1 may be the most crucial in the disclosed troubleshooting process, to determine where the problem resides in a customer's system. Both the physical representation of a customer's DSL connection and the functional processes behind those connections can be considered in terms of layers which the technician must investigate in a logical order to assess the nature and probable cause of a problem. Six such layers are depicted in FIG. 2 and discussed herein, in the context of the disclosed embodiment intended for troubleshooting a customer's DSL connection as represented in FIG. 3. Layer 1, shown on FIG. 2 at 200, is part of identifying the scope of the customer's problem. Although the customer may present the problem in relatively broad or undefined terms, Layer 1 seeks to determine the specific nature of that problem. For example, in the disclosed context of a DSL service, Layer 1 seeks to determine whether the customer's problem is a connectivity issue in the communication path between the customer's computer and the internet service provider (ISP), or whether the problem resides in a particular application on the customer's computer. For example, if a customer complains that he can't surf, the present methodology prompts the technician to verify whether the customer can use other applications such as e-mail clients or chat programs, or whether he can surf to other web pages. If the customer has connectivity using one of the other available applications, that will be a good indication that the problem resides at Layer 6, applications, shown at 250 on FIG. 2.

FIG. 3 illustrates the several layers discussed herein, with respect to the location of those layers in the chain of connectivity hardware and function extending from the customer's computer 302 to the ISP 304 providing internet service to that customer. The connectivity links include, by way of example, a local-area network (LAN) 306 extending from the customer's computer 302 to a LAN router and a DSL modem designated in FIG. 3 as customer-premises equipment (CPE) 308, and a line 310 extending from the modem to a digital subscriber line access multiplexer (DSLAM) 312 which, in turn, passes signals through a high-speed line 314 to and from the internet as represented by the ISP 304. The DSL modem and other CPE 308 may be supplied either by the ISP or by a third party; in either case, that modem usually is located at the customer's premises and is considered as customer premises equipment 308.

For the present illustrative embodiment, it is assumed the customer cannot connect using any application. The technician, having thus identified the scope of the problem, then proceeds to Layer 2, element 210 on FIG. 2, verifying sync. Level 2, as illustrated in FIG. 3, concerns the connection 310 between the customer's modem at the CPE 308 and the DSLAM 312 (typically physically sited at the premises of the ISP 304). At this layer, the technician must check the modem 308 for sync; as understood by those skilled in the art, a customer without sync will not be able to connect through the modem 308 to the ISP 304. For example, the technician at this level may be prompted to check for relevant changes at the customer's premises (e.g., an added alarm system, a new telephone or fax machine, or other apparatus recently connected to the telephone line at the customer's premises).

Layer 3, element 220 shown in FIG. 2, deals with communication from the LAN side of the customer's CPE 308 to the customer's computer 302. Most likely, the customer's computer 302 will obtain an IP address from the router associated with the CPE 308 using DHCP as understood by those skilled in the art. If the technician at Layer 3 does not receive a valid IP address, further levels of troubleshooting at Layer 3 are needed. However, if the technician receives a valid IP address, the methodology then moves to Layer 4 at 230, focusing on the connection from the customer's computer 302 to the GUI at the CPE 308. At this level, the technician seeks to ensure that the customer is able to connect, keeping in mind that sync (previously checked herein) is not the same as connection. In the present context, sync is the connection between the modem forming part of CPE 308 in the present example, and the DSLAM 312. At Layer 4, some typical points the technician can check are whether the customer can open the GUI using the default gateway IP address, whether the customer can ping the default gateway in case he is unable to,open the GUI, and whether the CPE GUI will connect and obtain a valid IP address from the ISP 304. Other steps might be required, as will be understood by those skilled in the art.

If the customer remains unable to surf, the technician continues to Layer 5, illustrated at 240 at FIG. 2 and comprising authentication over the connection from the WAN IP side of the CPE 308 through the network to the ISP 304. Techniques for determining whether a disruption exists in the WAN connection are known to those skilled in the art and need not be repeated herein.

Layer 6, element 250 in FIG. 2, deals with the applications on the customer's computer 302. From a connectivity standpoint these applications comprise software on the customer's computer 302 used to access the internet, such as e-mail clients, internet browsers, and instant messaging programs. Within these programs, there are settings that need to be checked and tested for proper operation. These settings include:
LAN settings
Proxy settings
PING
Trace route
Anti-virus
Firewalls
Winsock

At this point (as with others in the exemplary embodiment) the technician is prompted to query the customer to access the various settings on the applications at the customer's computer 302. If any setting, as reported to the technician by the customer, appears incorrect, the technician will advise the customer to select or otherwise enter the proper setting at the customer's computer 302.

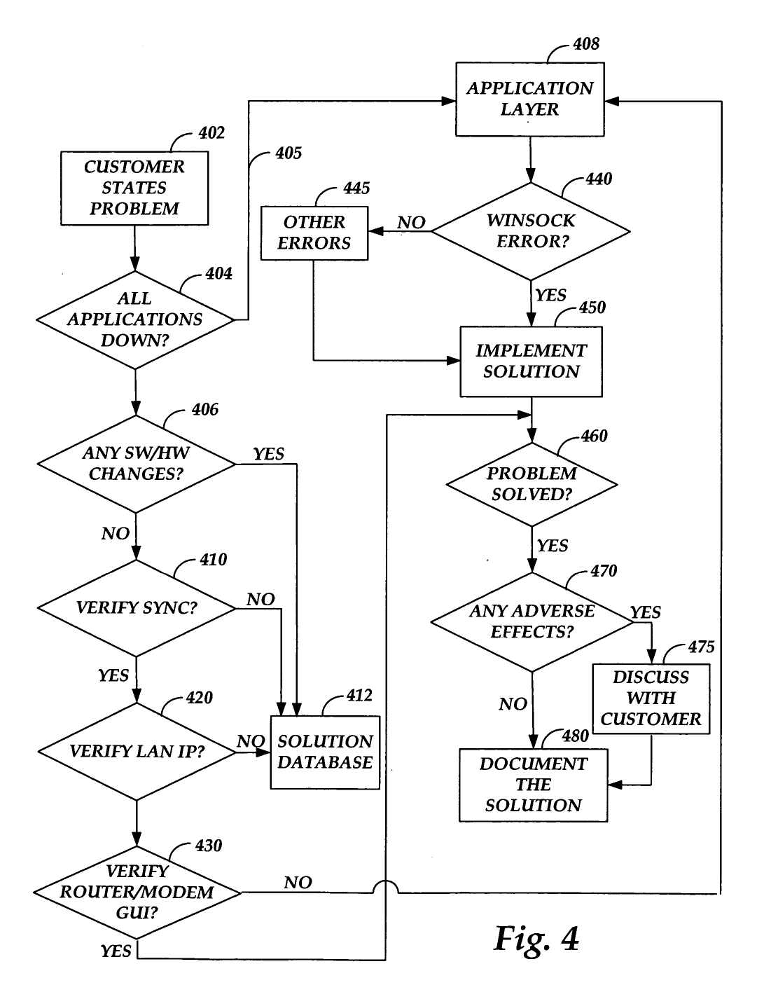

Having outlined the step-by-step methodology to troubleshooting a problem according to the disclosed embodiment, and the various layers comprising several steps in that methodology, FIG. 4 illustrates an example of the troubleshooting methodology applied to a particular hypothetical problem presented by a customer to a helpdesk technician. The following discussion illustrates an application of the preferred embodiment to the systematic evaluation of the problem presented by the customer and implementation of a solution to that problem, but those skilled in the art will understand that FIG. 4 does not extend to a solution for every problem that may arise in troubleshooting a particular system, namely, DSL service, as those solutions for that particular system and others will be known to those skilled in the art. With that understanding, at 402 in FIG. 4, it is assumed a customer calls a helpdesk and informs the technician that she cannot surf. With that statement alone, the technician has performed the first step (step 100 in FIG. 1), identifying the symptom of the customer's problem. The technician then moves to the second step, namely, identifying the scope of the problem, at 404 in FIG. 4. At that step, the technician wants to identify the scope of the customer's problem. To do so, the technician asks the customer to open her web browser and read any possible error message. The technician then asks the customer to try to surf other web pages or, if that is unsuccessful, to open other programs such as an e-mail client or chat program and check for activity. If there is no activity and the customer is unable to use those applications as well, the technician knows that the problem is not limited to a single application. Thus, with the present procedure the technician has identified the scope of the problem and now moves to the third step, namely, establishing whether any changes were made to the hardware or software of the customer's system, shown at 406 in FIG. 4.

If at 404 the technician had determined that the customer's problems did not affect all applications, the present procedure would branch at 405 to direct the technician to investigate the application layer, at 408 in FIG. 4. That application layer corresponds to Layer 6, shown at 250 in FIG. 2. However, for the present discussion, it is assumed the customer is having connectivity issues and has not made any recent hardware/software changes. With those assumptions, the methodology proceeds to determining the most probable cause of the customer's problem (130 in FIG. 1). This determination proceeds logically through Layers 2 through 6, starting with Layer 2 (verifying sync) at 410 in FIG. 4. To do so, the technician asks the customer to look at the modem in CPE 308 and report whether the appropriate light is solid green. If it is, the technician knows the customer's modem is in sync and will then proceed to Layer 3, verifying the LAN IP, at 420 in FIG. 4.

If at 410 the technician determined that the customer's modem was not in sync, the methodology would branch to the troubleshooting database 104 and advise the customer of a solution as at 412. In the case of a modem lacking sync, that solution may simply comprise powering down and then re-powering the modem as known to those skilled in the art.

Assuming for the present example that the modem is in sync, the computer-implemented methodology guides the technician to proceed to Layer 3, 430 in FIG. 4, to verify that the customer's computer 302 has a valid IP address, subnet mask, and default gateway. The technician is prompted to accomplish this by asking the customer to enter IP config at the command prompt on the customer's computer 302. If those elements are correct, at the next step the technician is prompted to investigate the TCP/IP properties to make sure that the customer's computer 302 is set to obtain an IP address automatically. This would ensure that the customer's computer 302 is talking to the CPE 308, which leads to Layer 4, accessing the GUI of the modem, at 430. For example, the technician may be instructed to try to ping the CPE 308 to establish two-way communication and surf into the CPE 308 using the default gateway address. If the technician is successful in that attempt, she can then try to authenticate and validate the username and the password of the customer.

In the present example, the technician is enable to access the customer's GUI. The methodology thus bypasses Layer 5 and proceeds to Layer 6, applications, at 408 as mentioned above. The troubleshooting procedure advises the technician of several tasks that should be performed at the application layer, such as investigating Winsock, proxy settings, and firewalls, the main culprits for a sync-no surf issue when the procedure reaches the application layer. If a Winsock error is determined at 440 in FIG. 4, the technician determines a solution presented by the solutions database 106 available to the technician, and the procedure moves to implementation of the solution at 450 followed by testing the solution at 460. In the present application, following implementation the solution is tested by asking the customer to attempt to surf. If the customer can do so, the technician next is prompted at 470 to see whether any adverse effects are known from this implemented solution and, if any are in the solutions database 106, to discuss those adverse effects with the customer at 475. Otherwise, the customer's problem is solved, and the technician documents the solution as shown at 480 in FIG. 4.

Reverting to 440 in FIG. 4, if a Winsock error is not determined, the methodology at 445 steps the technician to systematic procedures for evaluating in turn other probable causes of the customer's problem and solutions to those other causes. As previously mentioned, the set of probable causes and solutions depends on the computer system to which the present methodology is applied, and FIG. 4 is not meant to illustrate every possible cause and solution for problems a DSL-service may encounter.

It should be understood that the foregoing relates only to a disclosed embodiment of the present invention, and that numerous changes and modifications thereto may be made without departing from the spirit and scope of the present invention as defined in the following claims.

1. A computer-implemented process for use by an operator in troubleshooting a problem in a computer-implemented system of a customer in which the computer-implemented system is used in connection with an internet service provided for the customer, the computer-implemented system implemented with plural application programs associated with a customer's computer with which the customer is attempting to use the internet service, the process comprising:
identifying a symptom of the problem;
identifying outer limits of the symptom by determining whether the customer has connectivity to fewer than all the application programs associated with the computer, thereby determining whether the problem is a connectivity issue with the internet service provider or whether the problem is with one of the plural application programs associated with the customer's computer, so as to determine the scope of the problem in the computer-implemented system;
determining whether any change to the computer-implemented system was made before the problem arose;
identifying a probable cause of the problem;
locating in a database a probable solution to the probable cause, the probable solution being one of a plurality of possible solutions;
implementing the probable solution to determine whether the probable solution solves the problem in the computer-implemented system;
if the probable solution fails to solve the problem, reverting to the database to locate a second probable solution and implementing the second solution; and
after determining that one solution of the plurality of possible solutions in the database solves the problem, documenting the one solution in a the database so as to provide a template for future reference if the customer again requests assistance with the same problem.

2. The computer-implemented process as in claim 1, further comprising:
after the one solution is determined to solve the problem, identifying potential effects of the one solution and explaining any such effects to the customer.

3. (canceled)

4. The process as in claim 1, wherein:
if the problem is determined to be a connectivity issue because the customer cannot connect to any available internet application program, verifying whether synchronization exists between the internet service provider and customer equipment relating to providing the service.

5. The process as in claim 4, wherein:
if synchronization is not verified and is thus determined to be a problem, advising the customer how to restore synchronization to the equipment at the customer's premises.

6. The process as in claim 4, wherein:
if synchronization is verified and thus is not determined to be a problem, determining a current IP address used at the customer's equipment is valid.

7. The process as in claim 6, wherein:
if the current IP address is determined to be valid, determining whether the connection between the customer's computer and the internet service provider is valid.

8. The process as in claim 7, wherein:
if the connection is determined to be valid, investigating whether one of the application programs associated with the computer used by the customer is the cause of the problem.

9. The process as in claim 1, wherein identifying the probable cause comprises:
predetermining plural possible causes of the problem, within the identified outer limits;
ranking those possible causes in a logical predetermined order so as to provide a set of layers for testing the causes of the problem; and
testing the possible causes in order of the ranking so as to implement possible solutions in the order of the layers of possible causes.

10. A system for use by an operator in troubleshooting a particular problem encountered by a customer in a computer-implemented system of the customer, in which the computer-implemented system is used in connection with an internet service provided for the customer, the computer-implemented system implemented with plural application programs associated with a computer with which the customer is attempting to use the internet service, the system comprising:
at least one database comprising, separately or together, process flow data associated with certain problems that may arise with respect to the customer's system and solution data associated with a predetermined array of probable solutions to the certain problems;
a processor for accessing the process flow data to assist in identifying a symptom of the particular problem in the customer's system, in identifying outer limits of the symptom so as to determine the scope of the particular problem, in determining adverse effects if a change to the customer's system was made before the symptom arose, and in identifying a probable cause of the particular problem;
the processor identifying the outer limits by accessing process flow data for determining whether the customer has connectivity to fewer than all the application programs associated with the computer, thereby determining whether the problem is a connectivity issue with the internet service provider or the problem is with one of the plural application programs associated with the computer with which the customer is attempting to use the internet service;
the processor being operative for accessing the solution data in the database to assist in identifying a first probable solution to the probable cause, the first probable solution being one of a plurality of possible solutions, implementing the first probable solution to determine whether the first probable solution solves the particular problem in the customer's computer-implemented system, and reverting to the database to locate a second probable solution and implementing the second probable solution if the first probable solution fails to solve the particular problem; and
after determining that one solution of the plurality of possible solutions solves the particular problem, the processor documenting the one solution in the database so as to provide a template for future reference if the customer again requests assistance with the problem.

11. The system as in claim 10, wherein:
the processor is operative to identify potential effects of the one solution, after the one solution is determined to solve the problem, so as to enable explaining any such effects to the customer.

12. (canceled)

13. The system as in claim 10, wherein the processor:
identifies the probable cause by accessing process flow data associated with predetermined plural possible causes of the particular problem;
ranks those possible causes in a logical predetermined order so as to provide a set of layers for testing the causes of the problem; and
tests the possible causes in order of the ranking so as to implement possible solutions in the order of the layers of possible causes.

14. A method for troubleshooting a problem in a computer-implemented system comprising an internet service provided for a customer and implemented with plural application programs associated with a computer with which the customer is attempting to use the internet service, the method comprising:
identifying a symptom of the problem;
identifying outer limits of the symptom so as to determine the scope of the problem in the system by determining whether the customer has connectivity to fewer than all the application programs associated with the computer, thereby determining whether the problem is a connectivity issue with the internet service provider or the problem is with one of the application programs associated with the computer with which the customer is attempting to use the internet service;
determining whether any change to the computer-implemented system was made before the problem arose;
identifying one probable cause of the problem;
locating in a database a probable solution to the probable cause, the probable solution being one of a plurality of possible solutions;
implementing the probable solution to determine whether the probable solution solves the problem in the computer-implemented system;
if the probable solution fails to solve the problem, reverting to the database to locate a second probable solution and implementing the second probable solution; and
after determining that one solution of the plurality of possible solutions in the database solves the problem, documenting the one solution in a the database so as to provide a template for future reference if the customer again requests assistance with the same problem.

15. The method as in claim 14, further comprising:
after the one solution is determined to solve the problem, identifying potential effects of the one solution and explaining any such effects to the customer.

16. (canceled)

17. The method as in claim 14, wherein:
if the problem is determined to be a connectivity issue because the customer cannot connect to any available internet application program, verifying whether synchronization exists between the internet service provider and customer equipment relating to providing the service.

18. The method as in claim 14, wherein identifying the probable cause comprises:
predetermining plural possible causes of the problem;
ranking those possible causes in a logical predetermined order so as to provide a set of layers for testing the causes of the problem; and
testing the possible causes in order of the ranking so as to implement possible solutions in the order of the layers of possible causes.
